(19) United States
(12) Patent Application Publication
(10) Pub. No.: US 2006/0251471 A1
(43) Pub. Date: Nov. 9, 2006

(54) Manual adjustment device for headlamps

(76) Inventors: Wei-Gen Chen, Tainan (TW); Hsin-Hsiung Chiang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/123,024

(22) Filed: May 6, 2005

(51) Int. Cl. B60B 33/00

(52) U.S. Cl. 403/122

(57) ABSTRACT

A stamped ball socket includes a base having a recess defined in a top thereof and a spherical hole is in communication with the recess. A plate is fixedly to the top of the base and has a through hole. At least two lock-in fingers extend inward and inclinedly from an inner periphery of the through hole and are located in the recess. An adjuster has a pivot ball which extends through the through hole of the plate and is received in the spherical hole of the base. The lick-in fingers are engaged with the pivot ball.

### FIELD OF THE INVENTION

The present invention relates to a manual adjustment device for headlamps and more particularly, to a adjustment device with simplified structure and the adjustment rod is securely positioned.

### BACKGROUND OF THE INVENTION

A conventional manual adjustment device for headlamps is disclosed in US 2003/0143019A1 and generally includes a stamped ball socket 10 with a base 60 and four walls 80 which are bend from a piece of metal plate so as to form the base 60 and the four walls 80. Each wall 80 is further bent into an inclined tab 90 and a lock-in finger 100 which extends into a space encompassed by the walls 80. A hole 70 is defined through the base 60. The socket 10 is fixed to the headlamp pod 20 by a screw 30 and a pivot ball 50 extends through the hole 70 and is engaged with the lick-in fingers 100. By operating the pivot ball 50, the users may manually adjust the headlamps.

However, the socket requires at least three steps to complete, a metal plate is first cut to be a cruciform plate and then the walls are bent upward. The tabs are then bent and adjusted to form the lock-in fingers. This takes too much time. The height of the socket is too high so that the whole assembly including the headlamp pod becomes too bulky which is not welcomed by the customers in the market. Besides, only one screw is used to fix the headlamp pod which might be loosened due to shaking and vibration. The pivot ball 50 is not properly positioned so that the headlamp pod might side along the pivot ball. Furthermore, the walls are formed by bending the metal plate so that they might not be bent precisely and this affects the positioning of the pivot ball.

The present invention intends to provide a manual adjustment device for headlamps and which is easily to manufacture and assembled. The pivot ball is well positioned and the stamped ball socket is securely fixed to the headlamp pod.

### SUMMARY OF THE INVENTION

The present invention relates to a stamped ball socket that includes a base with a recess defined in a top thereof and a spherical hole is located in the recess and communicates with the recess. A plate is fixedly to the top of the base and has a through hole. At least two lock-in fingers extend inward and inclinedly from an inner periphery of the through hole and are located in the recess. An adjuster has a pivot ball at one end thereof and the pivot ball extends through the through hole of the plate and is received in the spherical hole of the base. The lick-in fingers are engaged with the pivot ball.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the stamped ball socket of the present invention;

FIG. 2 is a perspective view of the stamped ball socket of the present invention;

FIG. 3 is a cross sectional view to show the stamped ball socket of the present invention;

FIG. 4 is an exploded view to show another embodiment of the stamped ball socket of the present invention;

FIG. 5 is a perspective view of the stamped ball socket in FIG. 4 of the present invention, and FIG. 6 is a cross sectional view to show the stamped ball socket in FIG. 4 of the present invention.

### DETAILED DESCRIPTION OF THE PREFERRED EMBODIMENT

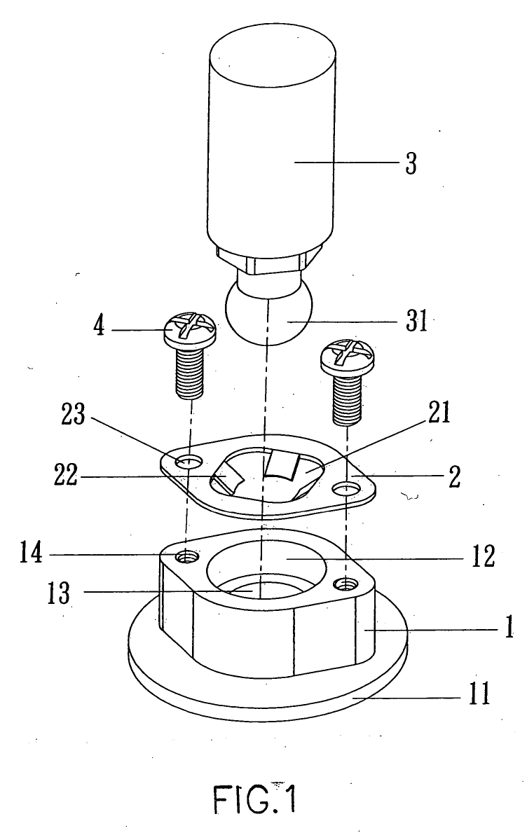

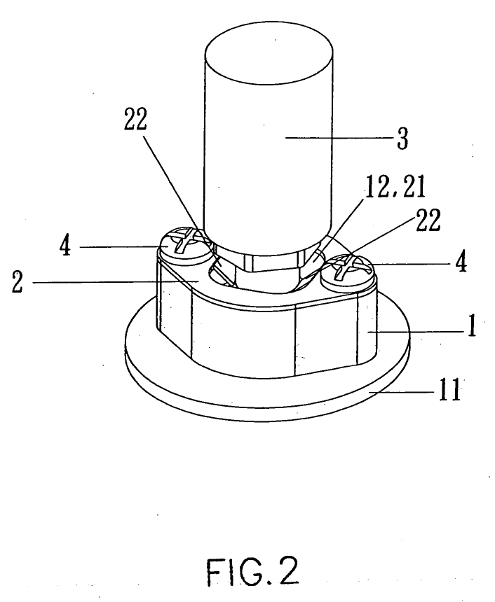

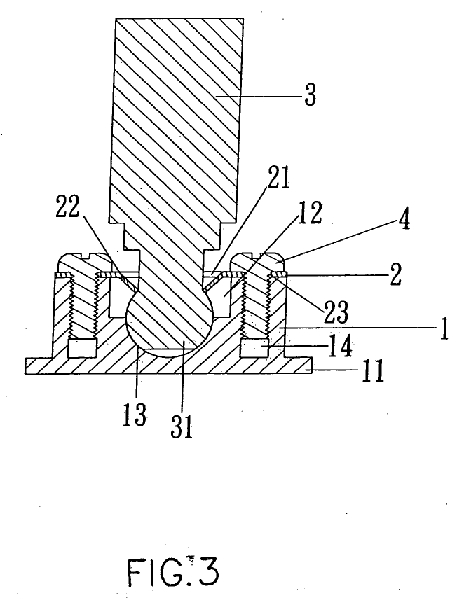

Referring to FIGS. 1 to 3, the stamped ball socket of the present invention comprises a base 1 having a recess 12 defined in a top thereof and a spherical hole 13 is located in the recess 12 and communicates with the recess 12. A flange 11 extends outward from an underside thereof so as to be connected to a headlamp pod which is not shown.

A plate 2 has a through hole 21 defined therethrough and at least two lock-in fingers 22 (in this embodiment there are four lock-in fingers) extend inward and inclinedly from an inner periphery of the through hole 21. The lock-in fingers 22 extend into the recess 12. The base 1 includes two threaded holes 14 defined in the top thereof and the plate 2 includes two connection holes 23, two bolts 4 extend through the two connection holes 23 and are threadedly engaged with the threaded holes 14. By this connection, the plate 2 is securely fixed to the base 1.

An adjuster 3 has a pivot ball 31 at one end thereof and the pivot ball 31 extends through the through hole 21 of the plate 2 and is received in the spherical hole 13 of the base 1. The lick-in fingers 22 are engaged with the pivot ball 31 so that the users can manually adjust the headlamp by operating the adjuster 3.

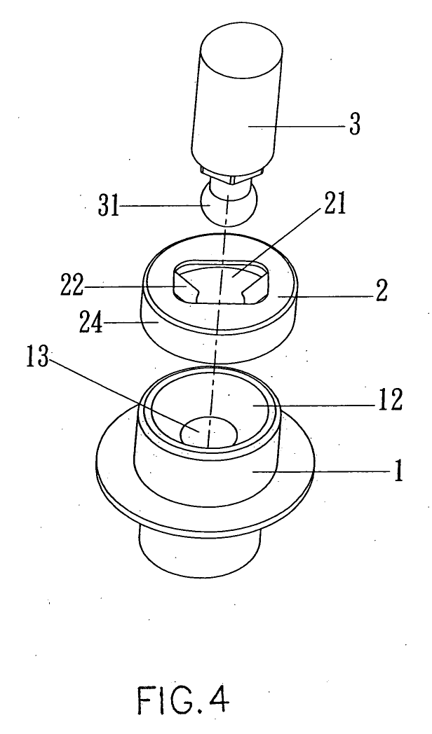

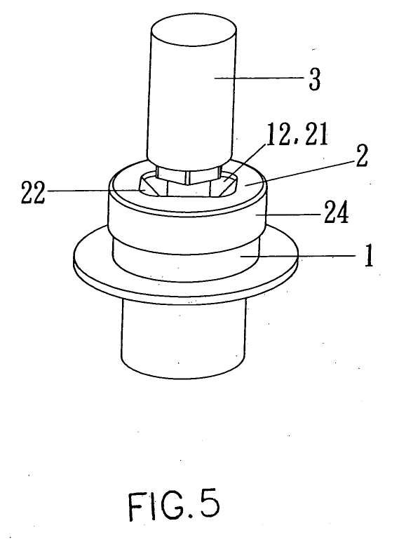

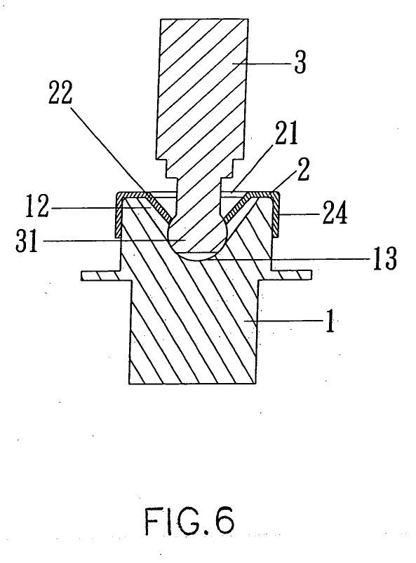

FIG. 4 to 6 show another embodiment of the stamped ball socket of the present invention, wherein a skirt portion 24 extends from a periphery of the plate 2 and the base 1 is enclosed by the skirt portion 24. An adhesive is applied on the top of the base 1 so as to fix the plate 2 on the base 1 without making the threaded holes 14 and the connection holes 23, and preparing the bolts 4.

While we have shown and described the embodiment in accordance with the present invention, it should be clear to those skilled in the art that further embodiments may be made without departing from the scope of the present invention.

What is claimed is:

1. A stamped ball socket comprising:
a base having a recess defined in a top thereof and a spherical hole located in the recess and communicating with the recess;
a plate fixedly to the top of the base and having a through hole defined therethrough, at least two lock-in fingers extending inward and inclinedly from an inner periphery of the through hole, the lock-in fingers extending into the recess, and
an adjuster having a pivot ball at one end thereof and the pivot ball extending through the through hole of the plate and received in the spherical hole of the base, the lick-in fingers engaged with the pivot ball.

2. The socket as claimed in claim 1, wherein the base includes two threaded holes defined in the top thereof and the plate includes two connection holes, two bolts extend through the two connection holes and are threadedly engaged with the threaded holes.

3. The socket as claimed in claim 1, wherein a skirt portion extends from a periphery of the plate and the base is enclosed by the skirt portion.

4. The socket as claimed in claim 2, wherein an adhesive is applied on the top of the base so as to fix the plate on the base.
